(19) United States
(12) Patent Application Publication
(10) Pub. No.: US 2010/0058882 A1
(43) Pub. Date: Mar. 11, 2010

(54) Oscillating or Low Speed Electric Machine Apparatus

(75) Inventor: Frederick William Klatt, Bedford, MA (US)

Correspondence Address: FREDERICK W. KLATT, 30 FOXRUN RD., BEDFORD, MA, 01730, US

(73) Assignee: Frederick William Klatt, Bedford, MA (US)

(21) Appl. No.: 12/545,251

(22) Filed: Aug. 21, 2009

Related U.S. Application Data
(60) Provisional application No. 61/094,962, filed on Sep. 7, 2008.

(51) Int. Cl. G01C 19/08

(52) U.S. Cl. 74/5.5; 74/5.7

(57) ABSTRACT

Electric Machines (i.e., electric motors or generators) convert electricity to mechanical work (or vice versa) by applying mechanical power to the shaft of the electric machine or extracting mechanical power form the shaft of the electric machine. This restricts the electrical characteristics, such as frequency or voltage, to the movement of the shaft of the electric machine in accordance to electric machine theory. In some cases, it is desired to perform electromechanical conversion from unorthodox movement, such as pulsating movement, slow movement, or low power movement. In many cases this is not possible with even electronic control without a transmission to convert the mechanical power to a compatible motion. However, by pre-establishing the compatible speed and inertial momentum of the rotor body of the electric machine while moving the entire body of the electric machine in accordance to the incompatible movement, the mechanical energy of the movement can be readily produced or absorbed to desired electrical characteristics.

### PRIOR ART

The properties of a gyroscope are well known. The properties are based on conservation of angular momentum, rotational kinematics (description of rotational motion), and rotational dynamics (the physics of body and environment in rotational motion). The fundamental relation for a gyroscope (or any moving body with angular momentum) is:

$$T = \frac{Δ L}{Δ t} = \frac{d ( I \times w )}{d t} = I \times α$$

### Where:

T Torque
ΔL change in angular momentum
Δt change in time
I scalar inertia

$$( I = \frac{1}{2} \times M \times {R}^{2} )$$

where:
   M mass
   R radius
W angular velocity
A angular acceleration

Since inertia is scalar

$$( I = \frac{1}{2} \times M \times {R}^{2} ) ,$$

a torque, T, will change the angular velocity, w, with time, which is angular acceleration, α.

Gyroscopes have been used to establish a reference for navigation and equilibrium due to two of its classic behaviors of precession and nutation as a result of applying external forces that cause torque (i.e., acceleration). To be a reference, a gyroscope must continually rotate at a constant reference speed (or angular velocity). Electric motors are commonly used to establish a constant angular velocity, w, while overcoming damping effects, such as bearing friction and wind resistance. Precession is the rotation of the gyroscope including its own spinning axis about an axis, like a top, perpendicular to the applied torque.

Force, torque (or product of force and distance), or angular momentum are vectors. In contrast, angular velocity and inertia are scalar quantities. Applying torque to an inertial mass with angular momentum (i.e., a spinning top) will change its angular momentum in a direction parallel to the applied torque with no change in the angular velocity (scalar value) of the spinning top with inertial mass. This movement in angular momentum is precession or rotation about an axis that is perpendicular to the applied torque. Since angular momentum is the vector sum of all angular momentum components of the system, which is the angular momentum of the spinning top and the angular momentum of precession of the spinning top, conservation of angular momentum is preserved and conservation of energy (do to the applied torque) is preserved.

U.S. Pat. No. 7,375,436 indirectly couples or transforms the precession of a standalone gyroscope due to an applied torque, which is always produced by gravity as the result of ocean waves, to a standalone electric generator through a set of cranks and transmissions. The standalone electric generator does not need moving electrical connections, such as slip-rings and brushes, because the cranks and gears fix the generator to the stationary frame of the platform.

U.S. Pat. No. 3,726,146 and U.S. Pat. No. 5,353,655 are exercising gadgets that holds a mass with angular momentum (i.e., spinning mass) within a groove during precession. This will cause the axle on each side of the spinning mass to act like wheels against the groove, which roll the axle and thereby increasing its speed. The purpose of the invention is to apply increasing force only with oscillating wrist movement but without regard to speed control or balancing of the inertial mass of angular momentum by synchronizing precession or using more than one spinning masses.

### OBJECT OF THE INVENTION

One object of the invention is an electric motor or generator apparatus that directly transfers controlled power between mechanical power of pulsating, oscillating, varying, and slow moving motion and electrical power by using gyroscopic principles or precession. The motional force could be applied by gravity, such in the case of a tidal wave generator, or applied to a shaft by a prime mover, such as an internal combustion engine or a wind turbine. Transferring between mechanical power of pulsating, oscillating, varying, and slow moving motion and electrical power is not compatible with the performance requirements of a rotating electric generator or motor (i.e., electric machine). Traditionally for these specific cases of motion, a transmission with gears and cranks is used to convert the unusual motion to compatible high speed rotary motion for the electric machine.
As used herein, “electric machine” is a rotating electric motor or electric generator.

Still another object of this invention is to change the inertia of the rotating rotor of an electric machine by motoring to smooth and compatibly produce or extract the pulsating, oscillating, or varying external energy with electric energy.

Still another object of this invention among other purposes is to establish an electrical means to stabilize structures, such as building, boats, etc., to produce electricity from oscillating tidal or wave energy, or to produce electricity directly at the speed of the wind turbine without high pole count electric generators.

Still another object of this invention is to apply two or more electric machines together in a configuration that balances the overall movement and electrical power of the apparatus.

Still another object of this invention is to change the characteristics of the oscillating motion, such as resonance, by changing the electrical parameters, changing the inertia, changing the damping, changing the speed of the inertial moving body, arranging more than one electric machines, or synchronizing the precession speed with the oscillating motion.

### BRIEF DESCRIPTION OF THE DRAWINGS

FIG. 1 illustrate the apparatus of the invention where wheels roll along a circular track do to the angular momentum of the rotor of an electric machine modulated with precession resulting from an applied vector of motion to the plane of the track. As a result, power is transfer between mechanical power of the vector of motion and electrical power of the electric machine.

FIG. 2 illustrates how more than one electric machine are evenly arranged in a star configuration or spoke configuration to balance electrical power or the affects of precession as the result of mechanical motion. In this case, four machines are arranged in a star configuration.

FIG. 3 illustrates the direction of precession, ΔL_{precession}, by applying torque, Torque_{Applied}, to an object with angular momentum, L_{orig}, showing L_{orig} becomes L_{origB} with applied torque. FIG. 3 is available in any physics book, is for reference only, and will not be explained further. It is noted that the direction of the vector of precession, ΔL_{precession}, is parallel to the direction of the applied torque, Torque_{Applied}, and as a result, the direction of the vector of precession will be the same or in the z axis direction, if the mirror image of vector, L_{orig}, was in the xy plane of the minus x axis, which demonstrates precession oscillates with a constantly applied torque. Beyond the two conditions described, the details of precession under the same applied torque becomes complex.

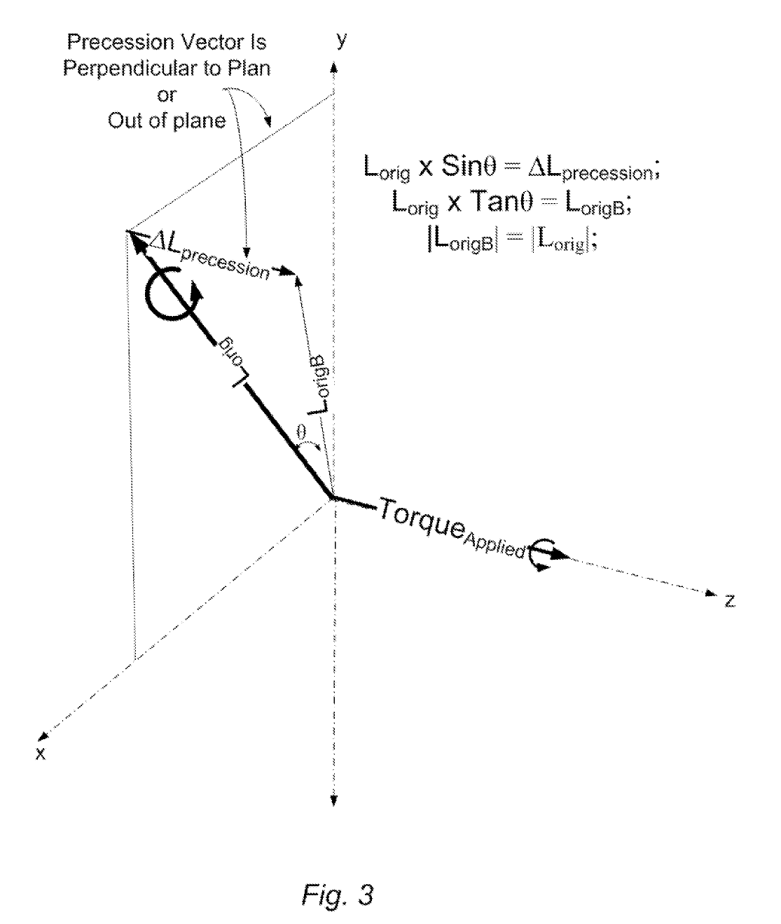

FIG. 4 illustrates another embodiment of the apparatus of FIG. 1 but within another body of coupled articulation. Effectively, the apparatus of FIG. 1 rotates along an axis by an applied vector of motion that is orthogonal to and is the result of another applied vector of motion.

### DETAILED DESCRIPTION OF THE INVENTION

There are situations where very slow rotation or oscillation motion must be converted to electricity or vise-versa. These types of motions burden or complicate the well known performance requirements and operating principles of rotating electric machines (i.e., electric motors or electric generators), which prefer high speed rotation. For instance, low speed electric machines require a high pole count, which means a very large diameter electric machine. Oscillating movement applied to electric machines is more onerous to the performance of the electric machine. Furthermore, the electrical power is pulsating as is the motion.

Traditionally, slow rotating or oscillating motion is converted to a high speed rotary motion, which is compatible with a rotary electric machine, by a transmission arrangement of multiple stages of gears, cranks, etc. These transmissions are inefficient, complex, and expensive with a motivation for innovative alternatives. One need only look at the wind turbine industry, which uses a complex, expensive, inefficient, multiple ratio stage gearbox to increase the low speed rotation of the propeller blades to a compatible high speed rotation for an electric generator. Besides long design and manufacture times that delay wind turbine deliveries, the transmission is large, heavy, and unreliable, which are incompatible with the logistics of the wind turbine installation.

Without a mechanical transmission of gears or cranks, etc. but by the gyroscopic principles of precession, the apparatus of this invention smoothly and efficiently transfers power between mechanical power with various styles, such as oscillating or low speed rotating motion, and high speed rotational power that is compatible with the performance requirements of a rotating electric machine, which results in electrical generating or motoring with various styles of motion.

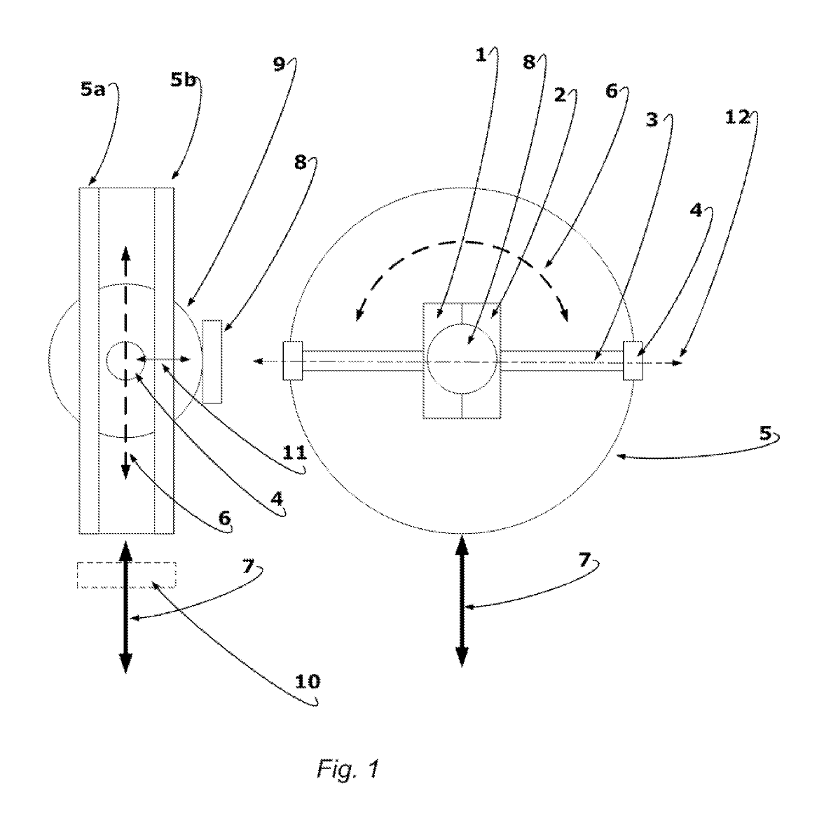

FIG. 1 shows the precession conversion method of the invention with a top and side view. The axis 12 of an electric machine 9, which is an electric motor and generator that consists of a stator body 1 and a rotor 2 body with an axle, rotates in a direction 6 but is confined parallel to a plane depicted by path 5 by an upper raceway 5a and lower raceway 5b of a channeled ring structure (also depicted by path 5). As a result, the axis 12 will rotate, if the rotor body 2 of the electric machine 9, has an angular momentum and in addition, will process (i.e., act of precession), if a vector of external motion 7 is applied, such as an external torque applied parallel to the plane of path 5. The axis 12 of the electric machine, which references the axle of the electric machine, is prevented from straying outside of the circular path 5 by any means, such as a thrust raceway on the outside circumference of the ring structure, which is not shown for simplicity. It is noted that other structural methods or configurations with other articulated components are necessary and realizable that keeps the electric machine 9 confined to the path 5 as described. The culmination of all realizable methods that confine the axis of the electric machine within the plane as described will be referred to as the “Tracking Mechanism.” Further noted, the stator body 1 is fixed to the plane of the ring structure or tracking mechanism by any means that preserve precession of the axis of the electric machine, while allowing the rotor body to rotate relative to the stator body.

As shown, the wheels 4 are fixed to the axle 3, which is attached to the rotor body 2 of the electric machine. The rotor body 2 of the electric machine, the axle 3, and the wheels 4 are spinning at a rotational speed to allow the combined inertia and angular momentum to be a dynamic state of the system and an ingredient for precession. When a vector of external motion 7, such as oscillating or rotating torque, is applied in any direction (i.e., clockwise or counter-clockwise) parallel to the plane of the path 5, the rotor 2 of the electric machine 9 will process or rotate in a direction 6 within the circular path 5 by the gyroscopic physics of precession. The actual direction 6 is a formulated vector function of the vector of external motion 7 and the angular momentum of the rotor body 2 of the electric machine 9, which acts like a gyroscope. On each end of the axle 3, the wheels 4 are applied to the upper 5a or lower 5b raceways of the ring structure or tracking mechanism and roll in a fashion that preserve the direction and angular velocity of the angular momentum of the rotor body assembly as a result of friction between the wheels and the raceways. Any precession movement (or power) as a result of the vector of external motion will be transferred to the rotor 2 of the electric machine do to friction between the wheels 4 and the upper 5a or lower 5b raceways of the tracking mechanism. The force arrow 11 indicates opposing wheels 4 of the rotor body 2 may be applied on the upper or lower raceways depending on the vector of external motion 7 and the angular momentum of the rotor of the electric machine. It is noted that many means are available that keeps the wheels on its respective raceway to preserve the direction of angular momentum with respect to the direction 6 of the axis rotation of the electric machine, including the timely connection and disconnection of the wheels from the raceway.
As used herein, “Tracking Mechanism” will be synonymous with the mechanism that keeps the axis 12 of the electric machine within the circular plane of path 5 but allows the rotor body 2 to move relative to the stator body 1 of the electric machine 9, while allowing the wheels 4 to rotate on respective raceways.

Since the axis 12 of the electric machine 9 is free to move within the tracking mechanism, an electricity propagation means 8 is required for an electrical connection between the electric machine and the stationary plane of the entire invention apparatus. This electricity propagation means 8 can be a slip-ring and brush assembly, a position-independent (i.e., circular) transformer assembly, or a position-dependent (i.e., balanced phase) transformer assembly. The electricity propagation means may be single phase or multiphase. The transformers can be of any frequency but since the mutual inductance decreases with increasing frequency, the compactness and efficiency of the transformer will improve with frequency and high frequency transformers are preferred. Similarly, electricity propagation means 10 will propagate electricity to the stationary plane of the vector of external motion 7, if necessary.

Initially, electricity is applied to the electric machine 9 to establish an angular momentum of the rotor body 2 together with the wheels 4, and the axle 3. If the wheels are applied against the raceways of the tracking mechanism, the axis of the electric machine will rotate at a speed and direction dictated by the speed of the wheels within the plane of the tracking mechanism 5. Therefore, the rotational speed of the axis of the electric machine can be changed by changing the angular velocity (or angular momentum) with the rate of electricity applied to the electric machine 9. In addition, a vector of applied external motion 7 (such as an applied external torque) simply modulates the axis rotational speed by the precession force developed in accordance to the gyroscopic principles based on an applied external vector of motion and at least the angular momentum of the rotor body 2 of the electric machine 9. This disclosure uses “Vector of motion” as a term to describe a motional force, such as a continuous torque, a varying torque, a pulsating torque or an oscillating torque, and is a term of mechanical power. In accordance to the gyroscopic principles, the precession force on the axis of the electric machine with an angular momentum, which is applied to the wheels, the axle, and rotor body of the electric machine, is at its maximum when the axle 3 of the electric machine is perpendicular to the vector of external vector of motion 7. Since precession is kept rotating within the confines of the ring structure or tracking mechanism, the precession torque decreases to zero, which is the null position, as the axle moves parallel to the vector of external motion 7. Therefore, the power of the applied external vector of motion 7 is with periodic sinusoidal peaks and valleys with a frequency based on the rotational velocity of the axis of the electric machine. If the external vector of motion is continuously applied in a fixed direction, the precession force will oscillate about the null positions (i.e., zero torque locations or when the axis is parallel to the vector of external motion 7) with sinusoidal peaks and valleys on a cycle period of the rotational speed of the axis 12. If the applied vector of motion 7 is oscillating but synchronized to the cycle period of the rotational speed of the axis 12, the precession force will continue in one direction and accumulate. In essence, the precession force as a result of an external vector of motion 7 causes the rotational speed of the axis 12 of the electric machine to be modulated by the precession force. Since the rate of electricity applied to the electric machine, which also controls the angular momentum of the rotor body, can be control, the mechanical and electrical dynamics of this invention can be controlled, including precession. For instance, the intensity or style of the torque of the external vector of motion 7 can be controlled. Furthermore, the apparatus as described can motor or generator with slow rotating or oscillating external motions at the mechanical port (i.e., the location of the external vector of motion 7) and the electrical port at the electric machine, such as at the electricity propagation means 10. The process just described is reciprocal, by controlling the rate of electricity supplied or extracted from the electric machine, the angular momentum of the rotor body can be controlled and the motion and intensity of the applied torque can be controlled, including the motoring or generating of oscillating torque.

To reiterate, the force of precession modulation depends on the applied external vector of motion 7 and the angular momentum of the rotor of the electric machine. As a result, the base angular momentum determines the base frequency of electrical and vector of motion “power” and the rotation frequency of the axis of electric machine within the tracking mechanism. The rate of electrical power of the electric machine and the rate of mechanical power of vector of external motion are ideally equal. Ideally, the angular velocity of the angular momentum of the rotor body is set to a base speed that shows highest performance for the electric machine. This could mean the wheel diameter is smaller than the axle to increase the step up speed ratio between the slow speed of the axis of rotation of the electric machine and the speed of the rotor body for high performance electrical conversion

Since the wheels, the axle, and the rotor body rotate together, their combined function of angular momentum is of little difference from a static mechanical point of view. For instance, the diameter of the wheel may be the same as the diameter of the axle and effectively, there may be no wheel in this configuration. Or the diameter of the rotor body and the diameter of the wheel may be the same and effectively, there may be no axle in this configuration without electrical considerations for the magnetic core and the electrical windings. However, the diameter of the axle entity, such as the wheel rolling on the raceway (when applied), determines the angular momentum and the base rotational speed of the electric machine axle within the tracking mechanism and accordingly, determines the precession of the axis of the electric machine as a result of a vector of motion. As a result, the diameter of the wheel (or whatever rolls on the raceways) has affect on the mechanical and electrical dynamics of the apparatus, such as the frequency of power do to the rotational frequency of the axis or the angular velocity of the rotor body. Therefore, there may be other configurations that duplicate the wheels, the axle, and the rotor body, such as a single rotor body entity or wheels coupled to a gear coupled to the axle, or the axle without the wheels, etc.
As used herein, “axle” refers to the total combination of the wheel 4, axle 3, and rotor body 2 connections. As a result, the axle rolls on the race way is tantamount to saying the wheel, axle, and rotor body roll together on the raceway.

The advantages of the apparatus of this invention far outweigh the disadvantage. The disadvantage, which is unique to this invention, is the requirement of at least one articulated electrical connection or electricity propagation means 8 to propagate electricity from the rotating axis of the electric machine to the stationary tracking mechanism of the apparatus. Furthermore, another electricity propagation means 11 is needed to propagate electricity from the tracking mechanism to the stationary platform of the apparatus, if the tracking mechanism continually rotates as well. The advantages, which are unique to this invention, are: 1) the inertia of the gyro entity, which is the rotor body of the electric machine, is already substantial because of the materials used in the rotor core of the electric machine and is integral to the conversion method of this invention. But of course additional inertia may be needed; 2) The angular momentum of the inertia can be controlled with the rate of electricity of the inherent electric machine (i.e., electric motor and generator) and as a result, the vector of motion 7 can be controlled.

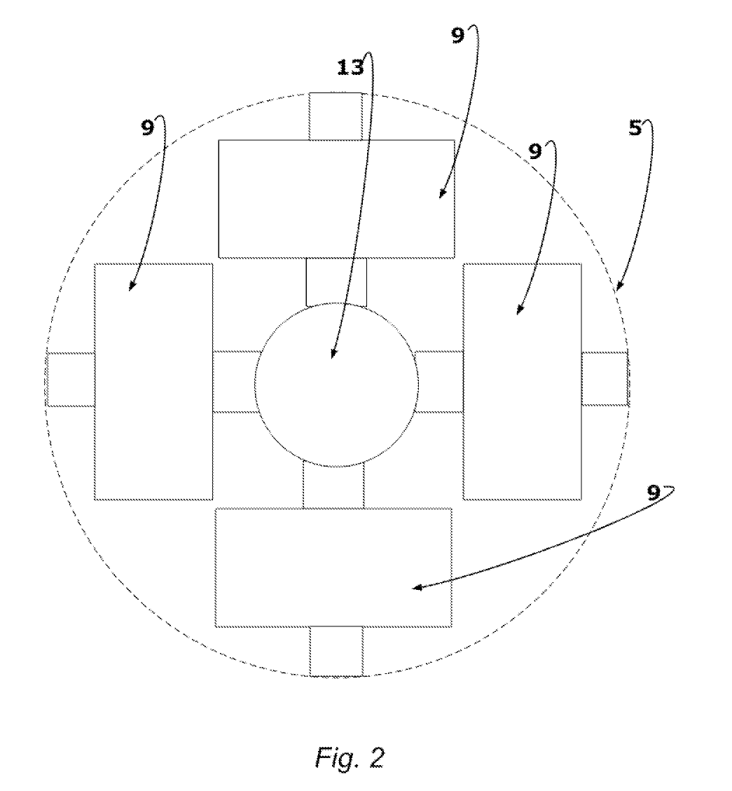

Since for every action there is a reaction, the potential oscillating force of precession will propagate to the stationary frame of the entire system and it may be necessary to incorporate more than one apparatus of this invention to cancel the reaction by synchronously working the dynamics of the system together. Furthermore, it is possible to control reaction somewhat by controlling the rate of electricity or the connection and disconnection of the axle of the electric machine from the raceway on a timely basis, such as by means of a discontinuous raceway, reapplying the axle to the raceway by lifting and lowering the axle, etc. FIG. 2 shows the invention with four electric machines 9 that are held together with a common hub 13 and rotate together. The hub 13 might incorporate articulation means, such as wheel connection or disconnection means to at least one raceway. The four electric machines are electrically connected and equally positioned within the plane 5 of the tracking mechanism like spokes of a wheel or a “star configuration.” Furthermore, the inertia and mass of each electric machine are balanced. Although FIG. 2 shows four electric machines, any number of electric machines beyond one that are equally positioned in the plane of the tracking mechanism will smooth the discontinuity of precession. For instance, three electric machines may be more compatible with a three phase AC circuit and with at least three electric machines in a star configuration, there will never be a null position or a position of zero precession torque. With the exception of more than one electric machine, the ingredients, such as the tracking mechanism, of FIG. 1 still apply but are not shown for simplicity. The precession force with its peaks and valleys is the sum of the precession force for each electric machine as these electric machines travel along their circular path, which for FIG. 2 equates to four precession forces that are 90 degrees out of phase with the four electric machines 9 and as a result, the total precession force, which is the sum of all phases of precession forces, becomes more smooth and constant. The more electric machine in a star configuration, the smoother and more constant is the total precession force. Furthermore, the star configuration is fail-safe because if one electric machine electrically fails in the star configuration, the hub connection keeps all electric machines (including the failed electric machine) at the same rotational speed and direction and the rolling axle or wheels of rotor body of each electric machine keep the rotor body of each electric machine at the same angular momentum.

There are other obvious arrangements for the precession conversion method of this invention. For instance, multiple instances (i.e., entities) of the apparatus shown in FIG. 1 could be stacked parallel to the circular plane 5, perpendicular to the circular plane 5, or at any angle to the circular plane 5.
As used herein, “electric machine” refers to an electric motor and generator with a rotor (or moving) body and a stator (or stationary body). The electromagnetic principles of electric machine operation are well known, which may require electronic control for optimum performance.
As used herein, “axle” or “wheel” or “rotor body” is mechanically synonymous because they mechanically move together and add to angular momentum, regardless if connected directly or through a set of gears.
As used herein, “axis” is the axial reference of an electric machine, such as the line drawn through the axle of the rotor body.
As used herein, “motion” or “vector of motion” is applying a mechanical force along a path with time, such as a torque vector that applies oscillating or rotating motion with the direction of a torque vector following the right-hand-rule of physics. As a result vector of motion exhibits mechanical power.
As used herein, “raceway” confines the axis of the electric machine. Therefore, a raceway could be a bearing surface or a gear surface, such as a pinion gear, which is connected to the axle of the electric machine, rolling on a ring gear.
As used herein, “tracking mechanism” is any method that keeps the axis of the electric machine confined to the plane of precession, such as one or more bearing surfaces or raceways.
As used herein, a “star configuration” of electric machines is an arrangement of more than one electric machine distributed evenly within the circular plane of the tracking mechanism.
As used herein, “electricity propagation means” is an articulated method for electrical connection integrity between a moving body and a stationary body, such as slip-rings and brush assembly or a circular rotating transformer.

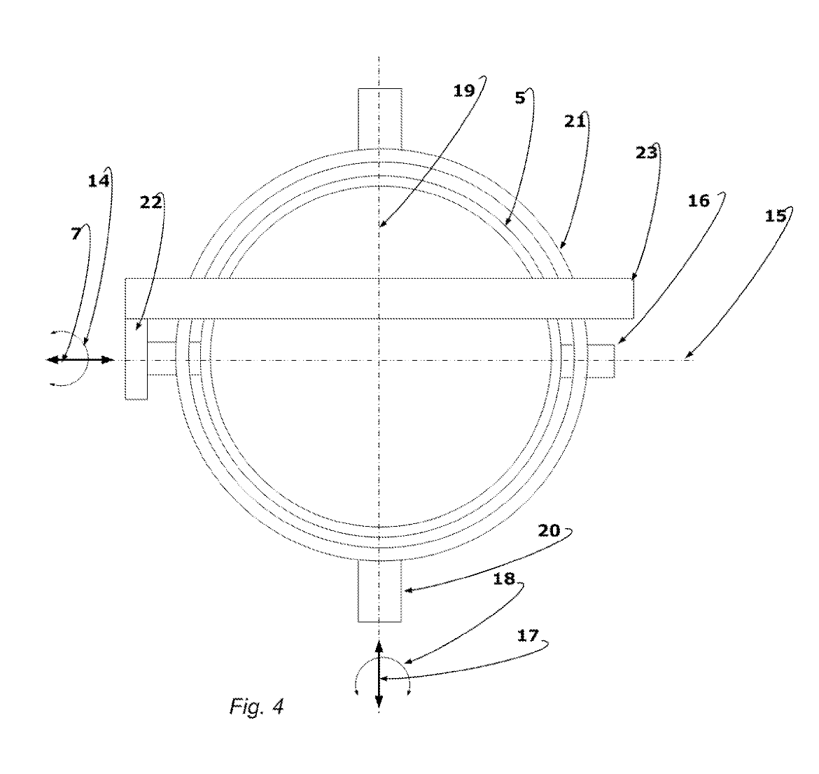

FIG. 4 is another embodiment of FIG. 1 where the tracking mechanism 5 rotates along an axis 15 by an applied vector of motion 7 which rotates 14 about an axle 16. The axle 16 of the plane of the tracking mechanism 5 rotates within another ring structure 21. The ring structure 21 rotates along its axis 19 by an applied second vector of motion 17 which rotates 18 about an axle 20. When a second vector of motion 17 is applied, a pinion gear 22 rotates along its ring gear 23 becomes a transmission means that applies or couples the second vector of motion 17 to the vector of motion 7 that is parallel to the plane of the tracking mechanism 5 as previously described using FIG. 1. Together, the ring gear 23 and pinion gear 22 is a simple approach and description of the transmission means. Other styles of transmission means should be obvious, such as hydraulic and electric pumps and motors as well as simple rolling or more complex gearing mechanisms. Not shown is the electric machine of FIG. 1 which rotates within the plane of the tracking mechanism 5. The principle of this embodiment is to give another level of articulation to the plane of the tracking mechanism 5, where an applied second vector of motion 17 is coupled to the vector of motion 7 of the plane of the tracking mechanism 5 by a transmission means, which may have advantages for styles of second vectors of motion 17. It should be noted that there are chassis structures and bearing assemblies of many styles, which are not shown or described but are necessary for static and dynamic mechanical integrity of the embodiment of FIG. 4. Furthermore, the gear or rolling ratio between the ring gear 23 and pinion gear 22 and the angular momentum of the rotor of the electric machine are related. Although axis 15 and axis 19 are orthogonal to each other, their special relation may be of other angles. The embodiment of FIG. 4 has two axis of coupled articulation of the tracking mechanism 5, which are axis 15 and axis 19, and several levels of electricity propagation means, which are not shown for simplicity of the figure, may be needed to propagate the electricity of the electric machine to some stationary plane of the entire platform.
As used herein, “coupled articulation” as describe in FIG. 4 is at least one level of articulation of the apparatus means described in FIG. 1, which includes the tracking mechanism and the electric machine where the vector of motion applied to the plane of the tracking mechanism results from a second vector of motion.

I claim:

1: A power conversion method between electrical power and mechanical power with a style of motion selected from a group consisting of pulsating, oscillating, varying, rotating, and slow moving vectors of motion comprising:
At least one electric machine:
Wherein electric motoring is first applied to establish an angular velocity of the rotating body of said electric machine:
Whereby said rotating body shows angular momentum;
Wherein said angular velocity of said rotating body is further determined by the rate of electricity applied to said electric machine;
At least one tracking mechanism:
Wherein said tracking mechanism has at least one raceway for confining the movement of the axis of said electric machine to the circular plane of said tracking mechanism:
Whereby the stator body of said electric machine does not move about said axis;
Whereby said rotor body of said electric machine moves about said axis relative to said stator body;
Wherein the roller of said rotor body of said electric machine rolls against said raceway in a direction and speed that preserves the angular velocity of said rotating body of said electric machine:
Whereby said axis of said electric machine rotates in said circular plane of said tracking mechanism by said rolling against said raceway;
Wherein said vector of motion is applied parallel to said circular plane of said tracking mechanism:
Whereby said axis of said electric machine will process according to the physics of precession within said circular plane of said tracking mechanism;
Wherein said angular velocity of said rotating body of said electric machine is modulated by said rolling of said roller against said raceway as the result of said precession:
Whereby said vector of motion is converted to a motion compatible with said electric machine;
Whereby power transfers between electrical power of said electric machine and mechanical power of said vector of motion.

2: The combination defined in claim 1, wherein more than one of said electric machine is arranged in a star configuration for balancing further selected from a group consisting of mass, inertia, angular momentum, precession force, and electricity balancing.

3: The combination defined in claim 1, wherein said angular velocity first applied by electric motoring is set to a speed consistent with the system performance further selected from a group consisting of said electric machine performance and the electrical distribution system performance.

4: The combination defined in claim 1, wherein the control of said electrical power and said mechanical power of said conversion method is selected from a group consisting of changing the rate of electricity applied to said electric machine, changing the inertia of said axis of said electric machine, changing the damping of said rolling of said roller of said electric machine, changing the angular velocity of said rotor body of said electric machine, connecting and disconnecting said roller with said raceway, changing the rolling friction between said roller of said electric machine and said raceway, changing the ratio between said roller and said raceway, and synchronizing said rotation of said roller with said vector of motion.

5: The combination defined in claim 1, wherein electrical power is propagated from said electric machine to the stationary platform of said conversion method by an electricity propagation method further selected from a group consisting of slip-rings and brushes, position-independent transformers, and position-dependent transformers.

6: The combination defined in claim 5, wherein the connection path of said electricity propagation method is further selected from a group consisting of single connection path, multiple connection paths, single phase connection path, and multiphase connection paths.

7: The combination defined in claim 5, wherein the frequency of said electricity propagation method is further selected from a group consisting of high frequency or low frequency.

8: The combination defined in claim 1, wherein said electric machine is further selected from a group consisting of singly-fed electric machines, doubly-fed electric machines, synchronous electric machines, asynchronous electric machines, reluctance electric machines, axial flux electric machines, radial flux electric machines, transverse flux electric machines, and electronically controlled electric machines.

9: The combination defined in claim 1, wherein said raceway is selected from a group consisting of flat, rolling, bearing, friction, and geared surfaces.

10: The combination defined in claim 1, wherein said roller is selected from a group consisting of wheels, axles, gears, and rotating body surfaces further selected from a group consisting of friction, diameter and gear ratios.

11: The combination defined in claim 1, wherein material applied to said raceway and said roller are further selected from a group that change performance of said rolling.

12: The combination defined in claim 1, wherein said conversion method is used to stabilize structures in an oscillating environment.

13: The combination defined in claim 1, wherein said conversion method comprises at least one level of coupled articulation.
